(19) United States
(12) Patent Application Publication
(10) Pub. No.: US 2025/0131594 A1
(43) Pub. Date: Apr. 24, 2025

(54) CALIBRATION SYSTEMS FOR MULTIPLE IMAGE SENSORS OF DIFFERENT LIGHT SPECTRUMS

(71) Applicant: GM Global Technology Operations LLC, Detroit, MI (US)

(72) Inventors: Sean Robert Wagner, Shelby Township, MI (US); Dmitriy Bruder, Clinton Township, MI (US); Megan E. McGovern, Detroit, MI (US)

(21) Appl. No.: 18/493,382

(22) Filed: Oct. 24, 2023

(51) Int. Cl. G06T 7/80; G01B 21/04

(52) U.S. Cl. CPC G06T 7/80; G01B 21/042

(57) ABSTRACT

A calibration system for multiple image sensors includes a manufacturing apparatus, a first imaging sensor, a second imaging sensor positioned at a different location than the first imaging sensor and configured to capture at least one different wavelength than the first imaging sensor, a calibration artifact, and an imaging calibration module. The imaging calibration module is configured to obtain first and second images of the calibration artifact via the first and second imaging sensors, determine first and second pixel mappings between the first and second images and a common coordinate system, according to a location of the calibration artifact in the first and second images, convert an image of a manufacturing object captured by the first imaging sensor to the common coordinate system, and convert an image of the manufacturing object captured by the second imaging sensor to the common coordinate system.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to calibration systems for multiple image sensors of different light spectrums, including manufacturing systems having visible light cameras and infrared cameras for thermal imaging.

During manufacturing of objects, such as vehicle components, different imaging sensors may be used to capture one or more images (e.g., a sequence of images) of the objects with different spectral wavelengths, such as visible light cameras and infrared cameras for thermal imaging. The different imaging sensors are normally positioned at different locations relative to the objects, and at different orientation angles relative to the objects, resulting in captured images (or sequences of images) that have different dimensions, resolutions, etc.

### SUMMARY

A calibration system for multiple image sensors includes a manufacturing apparatus configured to perform a manufacturing operation on a manufacturing object, a first imaging sensor configured to capture an image of the manufacturing object, a second imaging sensor configured to capture an image of the manufacturing object, wherein the second imaging sensor is positioned at a different location than the first imaging sensor and is configured to capture at least one different wavelength than the first imaging sensor, a calibration artifact located within a plane of the manufacturing apparatus, and an imaging calibration module. The imaging calibration module is configured to obtain a first image of the calibration artifact via the first imaging sensor, obtain a second image of the calibration artifact via the second imaging sensor, determine a first pixel mapping between the first image and a common coordinate system, according to a location of the calibration artifact in the first image, determine a second pixel mapping between the second image and the common coordinate system according to a location of the calibration artifact in the second image, convert an image of the manufacturing object captured by the first imaging sensor to the common coordinate system according to the first pixel mapping, and convert an image of the manufacturing object captured by the second imaging sensor to the common coordinate system according to the second pixel mapping.

In other features, the imaging calibration module is configured to perform image processing on the image of the manufacturing object captured by the first imaging sensor to identify a target region, and apply the target region to the image of the manufacturing object captured by the second imaging sensor using the common coordinate system.

In other features, the imaging calibration module is configured to control the manufacturing apparatus to perform the manufacturing operation on the manufacturing object according to the target region as applied to the image of the manufacturing object captured by the second imaging sensor.

In other features, the manufacturing apparatus is a weld inspection machine, and the manufacturing operation includes a weld inspection operation performed on the manufacturing object.

In other features, the first imaging sensor is a visible light camera, and the second imaging sensor is an infrared camera.

In other features, the imaging calibration module is configured to activate a light source to illuminate at least one of a front surface of the calibration artifact or a back surface of the calibration artifact while capturing the first image of the calibration artifact using the visible light camera, and thermally excite at least a portion of the calibration artifact while capturing the second image of the calibration artifact using the infrared camera.

In other features, the imaging calibration module is configured to capture a sequence of images while thermally exciting at least the portion of the calibration artifact, and select one of the sequence of images having a most uniform heat profile as the second image for determining the second pixel mapping.

In other features, the front surface of the calibration artifact includes a material configured to absorb and emit heat in the form of infrared radiation.

In other features, the imaging calibration module is configured to apply infrared radiation to the front surface of the calibration artifact to uniformly heat the calibration artifact while capturing the second image of the calibration artifact using the infrared camera.

In other features, the material on the front surface of the calibration artifact includes a paint material configured to absorb and emit heat in the form of infrared radiation.

In other features, the calibration artifact includes a rectangular plate having a front side, a back side, at least one chamfered corner, and an array of openings defined from the front side to the back side.

In other features, the rectangular plate defines a thickness from the front side to the back side, and each of the openings and each edge of the rectangular plate is chamfered.

In other features, the first imaging sensor is at a different distance from the calibration artifact than the second imaging sensor.

In other features, the first imaging sensor is oriented at a different angle with respect to the calibration artifact than the second imaging sensor.

A method of calibrating multiple image sensors includes obtaining a first image of a calibration artifact via a first imaging sensor, the calibration artifact located within a plane of a manufacturing apparatus configured to perform a manufacturing operation on a manufacturing object, obtaining a second image of the calibration artifact via a second imaging sensor, wherein the second imaging sensor is positioned at a different location than the first imaging sensor and is configured to capture at least one different wavelength than the first imaging sensor, determining a first pixel mapping between the first image and a common coordinate system, according to a location of the calibration artifact in the first image, determining a second pixel mapping between the second image and the common coordinate system according to a location of the calibration artifact in the second image, converting an image of the manufacturing object captured by the first imaging sensor to the common coordinate system according to the first pixel mapping, and converting an image of the manufacturing object captured by the second imaging sensor to the common coordinate system according to the second pixel mapping.

In other features, the method includes performing image processing on the image of the manufacturing object captured by the first imaging sensor to identify a target region, and applying the target region to the image of the manufacturing object captured by the second imaging sensor using the common coordinate system.

In other features, the method includes controlling the manufacturing apparatus to perform the manufacturing operation on the manufacturing object according to the target region as applied to the image of the manufacturing object captured by the second imaging sensor.

In other features, the manufacturing apparatus is a weld inspection machine, and the manufacturing operation includes a weld inspection operation performed on the manufacturing object.

In other features, the first imaging sensor is a visible light camera, and the second imaging sensor is an infrared camera.

In other features, the method includes activating a light source to illuminate at least one of a front of the calibration artifact or a back of the calibration artifact while capturing the first image of the calibration artifact using the visible light camera, and thermally exciting at least a portion of the calibration artifact while capturing the second image of the calibration artifact using the infrared camera.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example calibration system for multiple imaging sensors.

FIG. 2 is a diagram of an example calibration artifact for use in the calibration system of FIG. 1.

FIG. 3 is a block diagram illustrating an example process for mapping an identified target region between images captured by different imaging sensors, using a common coordinate system.

FIG. 4 is a flowchart depicting an example process for calibrating different image sensors to a common coordinate system.

FIG. 5 is a flowchart depicting an example process for mapping an identified target region between images captured by different imaging sensors, using a common coordinate system.

In the drawings, reference numbers may be reused to identify similar and/or identical elements.

### DETAILED DESCRIPTION

Some example embodiments described herein include systems and methods for fusing image data streams (or sequences of images) from imaging sensors operating at differing spectral wavelengths, to enable multispectral region of interest selection and mapping between the sensors. For example, a hybrid calibration artifact facilitates translation of different sensors to a common world coordinate system (WCS), where the hybrid calibration artifact includes a calibration pattern which can be detected at different spectral wavelengths of the different sensors.

Once sensor data has been properly mapped to a common WCS, region of interest identification based on image data from one sensor may be mapped to image data from another sensor (and vice versa) to improve analytical robustness of a given object observed in all spectral wavelengths of the sensors.

For example, a weld location may be identified with higher accuracy in an image captured by a visible light camera (e.g., due to higher resolution of the visible light camera), and the identified weld location may be applied to a same location in an infrared image using the common coordinate system mappings. Although some example embodiments described herein refer to mid-wavelength infrared (MWIR) sensors and visible light sensors, other example embodiments may include imager sensors in other spectral ranges.

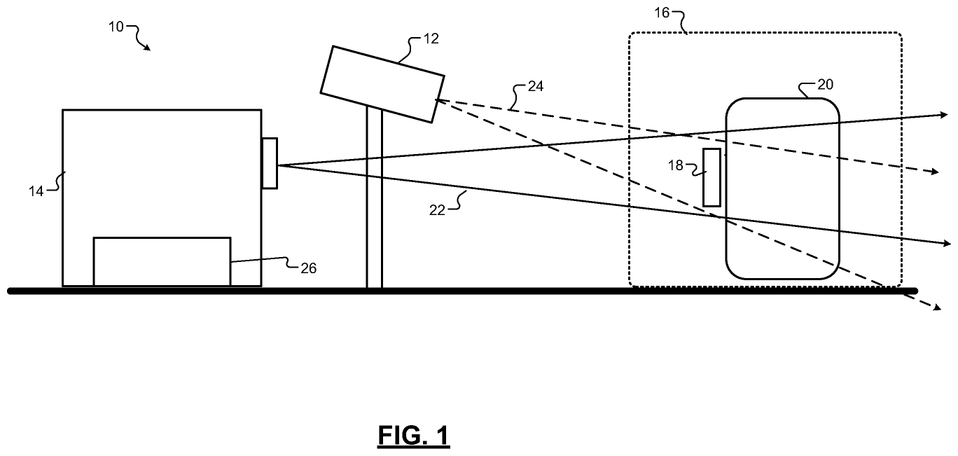

FIG. 1 a calibration system 10 for multiple image sensors. The calibration system includes a manufacturing apparatus 16 configured to perform a manufacturing operation on a manufacturing object 20. For example, the manufacturing apparatus 16 may be a welding machine configured to perform a welding operation on a component for assembling a vehicle.

The calibration system 10 includes a first imaging sensor 12 configured to capture an image of the manufacturing object 20, and a second imaging sensor 14 configured to capture an image of the manufacturing object 20. The second imaging sensor 14 is positioned at a different location than the first imaging sensor 12. In various implementations, the calibration system 10 first acquires data from a calibration object (such as the calibration artifact 18). The actual part is then moved into view so that data can be acquired.

For example, the first imaging sensor 12 and the second imaging sensor 14 may be located at different distances from the manufacturing object 20 (or may be located at a same distance), may be oriented at different angles with respect to the manufacturing object 20 (or may be located at a same orientation angle), etc. FIG. 1 illustrates the first imaging sensor 12 having an image capture field 24 which is oriented at a different angle than the image capture field 22 of the second imaging sensor 14.

The first imaging sensor 12 is configured to capture at least one different wavelength than the second imaging sensor 14. For example, the first imaging sensor 12 may be an optical camera configured to capture a visible light image of the manufacturing object 20, and the second imaging sensor 14 may be an infrared camera configured to capture an infrared image of the manufacturing object 20.

A calibration artifact 18 is located within a plane of the manufacturing apparatus 16. For example, the manufacturing apparatus 16 may include a conveyor, etc. configured to move the manufacturing object 20 in position for the first imaging sensor 12 and the second imaging sensor 14 to capture images of the manufacturing object 20. The calibration artifact 18 may be positioned at approximately the same location that the manufacturing object 20 is usually located, so the first imaging sensor 12 and the second imaging sensor 14 can capture images of the calibration artifact 18 at a similar position as the manufacturing object 20.

The calibration system 10 also includes an imaging calibration module 26. The imaging calibration module 26 is configured to obtain a first image of the calibration artifact 18 via the first imaging sensor 12, and obtain a second image of the calibration artifact 18 via the second imaging sensor 14.

The imaging calibration module 26 is configured to determine a first pixel mapping between the first image and a common coordinate system, according to a location of the calibration artifact 18 in the first image. For example, a common world coordinate system (WCS) may be used to calibrate the first imaging sensor 12 and the second imaging sensor 14, to facilitate translating image data between images captured by each imaging sensor.

Any suitable techniques may be used to generate the pixel mapping from the image of the calibration artifact 18 to the common coordinate system, which may account for sensor format, an angle of measurement relative to a plane of the calibration artifact 18, optics curvature, etc. The imaging calibration module 26 is configured to determine a second pixel mapping between the second image and the common coordinate system according to a location of the calibration artifact 18 in the second image.

The imaging calibration module 26 is also configured to convert an image of the manufacturing object 20 captured by the first imaging sensor 12 to the common coordinate system according to the first pixel mapping, and convert an image of the manufacturing object 20 captured by the second imaging sensor 14 to the common coordinate system according to the second pixel mapping.

For example, the imaging calibration module 26 may be configured to perform image processing on the image of the manufacturing object 20 captured by the first imaging sensor 12 to identify a target region, and apply the target region to the image of the manufacturing object 20 captured by the second imaging sensor 14 using the common coordinate system. In various implementations, the imaging calibration module 26 may use an image captured from a visible light camera to perform image processing and identify a target region of interest (ROI), such as identifying a weld location, where image processing is more accurate on a visible light camera image with higher detail.

The imaging calibration module 26 may then map the identified target region in the visible light image to a same target region in an infrared image captured by an infrared camera, to highlight the weld location in the infrared image, using the common coordinate system. For example, infrared images may have less accuracy, resolution, contrast, etc. as compared to visible light images, which may reduce the accuracy of image processing for infrared images (e.g., make it more difficult to identify a weld location in an infrared image).

The use of the common coordinate system allows for more accurate determination of the target region in the visible light image, which can then be translated over to an infrared image for use in performing operations or checks on manufacturing components. For example, the imaging calibration module 26 may be configured to control the manufacturing apparatus 16 to perform the manufacturing operation on the manufacturing object 20 according to the target region, as applied to the image of the manufacturing object 20 captured by the second imaging sensor 14.

The imaging calibration module 26 may be configured to activate a light source to illuminate at least one of a front surface of the calibration artifact 18 or a back surface of the calibration artifact 18, while capturing the first image of the calibration artifact 18 using the visible light camera. For example, a backlight of LEDs or another light source may be activated to increase the contrast of calibration artifact features as captured by the visible light camera. A front array of LEDs may illuminate the manufacturing object 20 to increase the accuracy and detail of an image of the manufacturing object as captured by a visible light camera.

The imaging calibration module 26 may be configured to thermally excite at least a portion of the calibration artifact 18, while capturing the second image of the calibration artifact 18 using the infrared camera. For example, a front surface of the calibration artifact 18 may include a material with high absorptivity and emissivity, such as a black paint material. The imaging calibration module 26 may be configured to apply light to the front surface of the calibration artifact to uniformly heat the calibration artifact 18 while capturing the second image of the calibration artifact 18 using the infrared camera.

In some example embodiments, the imaging calibration module 26 is configured to capture a sequence of images while thermally exciting the calibration artifact 18. The imaging calibration module 26 may then select one of the sequence of images having the most uniform heat profile as the second image for determining the second pixel mapping. For example, heating distribution over the calibration artifact 18 may vary in different regions, depending on how the calibration artifact 18 is thermally excited. The imaging calibration module 26 may capture a sequence of images over time, and select which image has a most uniform heat distribution for calibration purposes.

Although some example embodiments are described herein with reference to a visible light camera and an infrared camera, other embodiments may use other suitable types of image sensors, which may capture different wavelengths of light.

In various implementations, each sensor may have line of sight of the calibration artifact, where the full calibration artifact is visible and in focus. Each imaging sensor may have a sensor format with a high enough pixel density to observe the relevant calibration artifact pattern.

Each sensor is configured to detect the calibration artifact, such as via thermal excitation for infrared cameras to observe the calibration artifact. Lighting conditions or excitation scheme that produces spatially uniform spectral emission may be observed by each sensor. In some example embodiments, the calibration artifact may have a geometry that is tuned depending on which sensor(s) are off normal incident. For example, geometry related image artifacts induced for a particular sensor may be reduced, such as by use of chamfering on edges and openings of the calibration artifact to reduce edge effects and off normal incident shadowing effects in the imaging.

In some example embodiments, lighting, the calibration artifacts, imaging sensors, etc., may be positioned at fixed locations. Suitable materials may be selected for the calibration artifact, such as a matte black color for the infrared spectrum when infrared cameras for thermal imaging are used. Each calibration artifact may be designed to be detectable by all imaging sensors in the system.

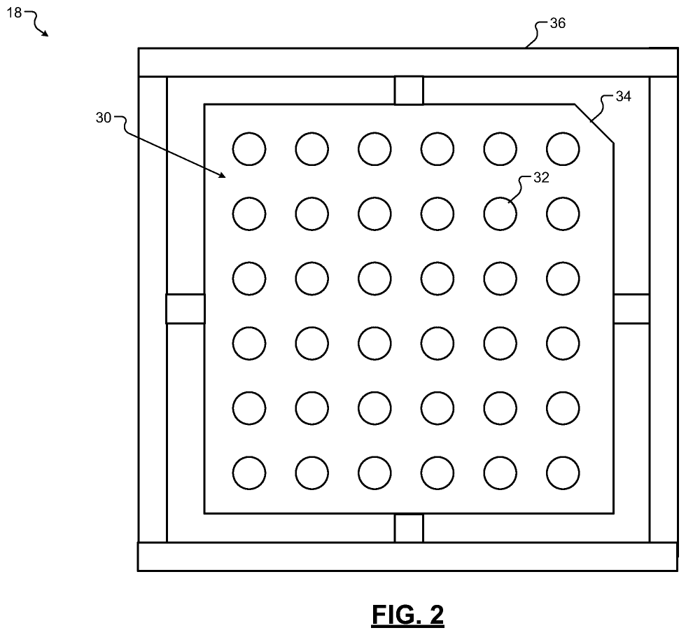

FIG. 2 is a diagram of an example calibration artifact for use in the calibration system 10 of FIG. 1. As shown in FIG. 2, the calibration artifact 18 has a rectangular (e.g., square) shape, with an array of openings 32. The openings 32 are defined from a front side 30 of the calibration artifact 18, to a back side of the calibration artifact.

The openings 32 may have any suitable shape, such as circular, rectangular, triangular, etc. Although FIG. 2 illustrates an array having six rows and six columns of openings 32, other example embodiments may have other suitable calibration patterns.

The openings 32 may allow for detection of a pattern in a visible light image capture (e.g., by shining a back light through the openings), as well as detection of the pattern in an infrared light image (e.g., where the material of the calibration artifact 18 has an increase heat profile when thermally excited, but the openings 32 do not). As mentioned above, other embodiments may use image sensors other than visible light cameras and infrared cameras for infrared images. The calibration artifact 18 may use a different pattern type other than openings 32, as long as the same pattern is detectable in both image sensor types. In some examples, the calibration artifact may have a pattern which enables the sensor to understand the orientation of the calibration artifact in three-dimensional space. The pattern may have a high contrast from the background. For thermography, one example includes creating a pattern out of holes, but in other examples the pattern may be created out of two different materials.

As shown in FIG. 2, the calibration artifact 18 includes a chamfered corner 34 (which may be cut at a forty-five degree angle, etc.). The chamfered corner 34 allows for a determination of orientation of the pattern of the calibration artifact 18, and may be useful where different image sensors may have different rotational orientations. Other example embodiments may have more or less chamfered corners, calibration artifacts having different shapes, other indicators for orientation of the calibration article, etc.

In some example embodiments, the rectangular plate of the calibration artifact 18 defines a thickness from the front side to the back side, so the image sensors may be able to detect a pattern or calibration in three dimensions. Each of the openings 32 and each edge of the rectangular plate may be chamfered, to reduce distortion and artifacts caused from “shadowing”/off-axis perspective, if an image sensor is positioned at a different angle relative to the calibration artifact 18.

In some example embodiments, the calibration artifact facilitates coordinate system fusion between multiple sensors in different spectral regimes simultaneously. This is enabled by a calibration artifact design which is detectable across all image sensor spectral regimes in the system.

For example, the calibration artifact may include features that enable high contrast between an artifact calibration pattern and a background. The calibration artifact may have a material and geometry that reduces or minimizes deleterious image features caused by spectral reflections, shadows, noise, perspective, etc.

The calibration artifact may enable uniform illumination and/or emission of an artifact calibration pattern and background, and may increase or maximize artifact pattern contrast for each image sensor spectral regime in the system. Example calibration artifact excitation/illumination methodologies may enable and optimize feature detection of the calibration artifact within image sensor spectral regimes used in the system. The excitation strategy may be dependent on the calibration artifact's latent effects, due to excitation in the spectral regimes of interest (e.g., by effecting an excitation sequence strategy when switching between spectral regimes of different image sensors).

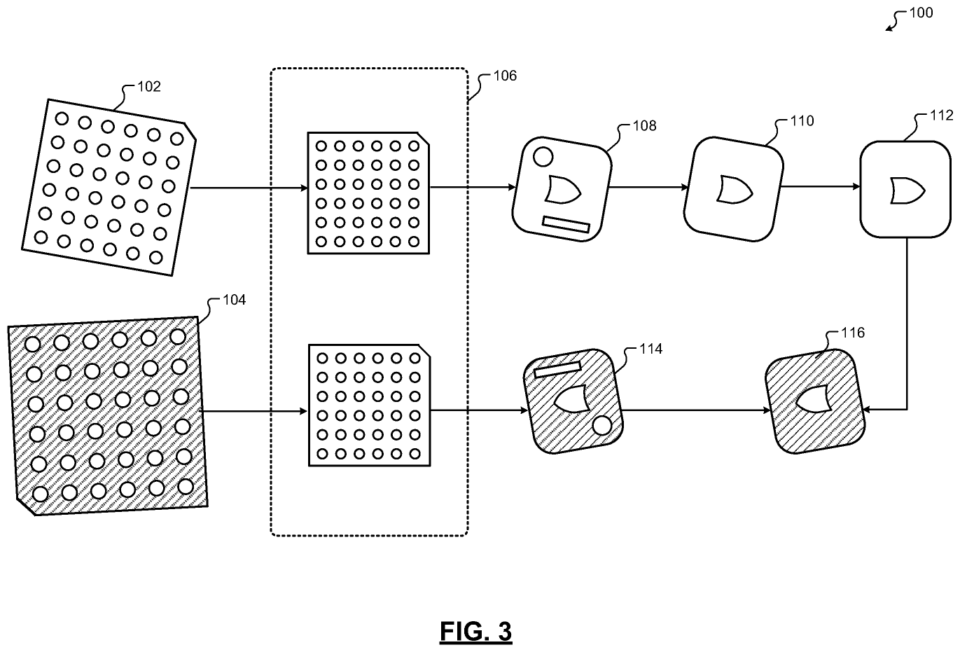

FIG. 3 is a block diagram illustrating an example process 100 for mapping an identified target region between images captured by different imaging sensors, using a common coordinate system. As shown in FIG. 3, a first image 102 is captured by a first image sensor, such as a visible light optical camera.

A second image 104 is captured by a second image sensor, such as an infrared camera. The first image 102 and the second image 104 may have different sizes, different rotational orientations, etc. In various implementations, the calibration artifact 18 does not move between image captures. In other words, the image data should be acquired from one fixed system position

The first image 102 and the second image 104 are mapped to a common coordinate view 106. For example, a pixel mapping translation process may use the calibration pattern in the first image 102 and the second image 104 to map each image to the common coordinate view 106, based on a stored relationship between the calibration artifact pattern and the common coordinate view 106.

At 108, the imaging calibration module acquires optical data for a manufacturing object, such as an object for welding. At 110, the imaging calibration module determines a segment weld region (or target region of interest). This may be performed by executing image processing on the visible light image, etc.

At 112, the imaging calibration module transforms the visible light image to the common coordinate view. Although FIG. 3 illustrates determining the target region of interest prior to converting the visible light image to the common coordinate view, in other example embodiments the system may convert the visible light image to the common coordinate view prior to determining the target region of interest in the visible light image.

The imaging calibration module is configured to acquire object infrared (IR) data at 114, such as via an infrared image capture of the manufacturing object. At 116, control performs a transformation of the ROI found in the visible light image to the infrared data, using the common world coordinate view mappings. For example, the identified ROI from the visible light image may be applied to the infrared image to identify a weld location in the infrared image for control checks, for performing a welding operation, etc. In various implementations, the infrared image capture of the object may be translated to the common coordinate view prior to applying the identified ROI from the visible light image, the identified ROI may be mapped from the common coordinate view to the infrared image coordinates based on a pixel mapping calibration, etc. In some examples, the infrared image data may provide a better (e.g., more accurate) means of ROI selection. In various implementations, the infrared image data may be used to select an ROI, and the selected ROI may then be applied to the visible light image.

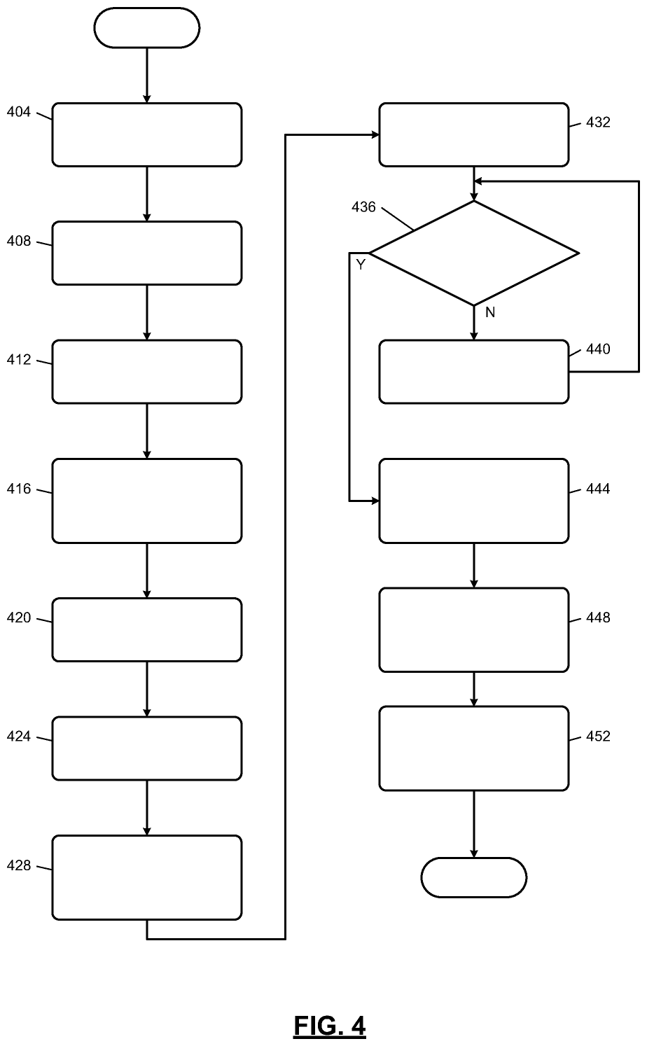

FIG. 4 is a flowchart depicting an example process for calibrating different image sensors to a common coordinate system. The process illustrated in FIG. 4 may be performed by, for example, the imaging calibration module 26 of FIG. 1.

At 404, the process begins by placing a calibration artifact in view of both image sensors. The imaging calibration module is then configured to apply a first imaging sensor stimulus at 408, such as by turning on an LED backlight. In some examples, the sensor stimulus may be built into the calibration object itself. For example, the calibration artifact may include embedded heating coils for a thermal excitation regime, or LED backlighting may be part of the calibration object.

At 412, the imaging calibration module is configured to capture first imaging sensor data via a first imaging sensor, such as a visible light camera. At 416, the imaging calibration module is configured to apply a second imaging sensor stimulus to the calibration artifact, such as thermally exciting the calibration artifact. The imaging calibration module then captures second imaging sensor data via a second imaging sensor, such as an infrared camera.

The imaging calibration module is configured to identify a pattern of the calibration artifact in the first image data at 424. The imaging calibration module then generates a first pixel mapping, from the identified first image pattern to common coordinates, at 428.

At 432, control is configured to select a first one of a sequence of image captures from second imaging sensor data. For example, an imaging sensor may capture a sequence of images, where control then attempts select one of the images where the calibration artifact was uniformly heated. Although FIG. 4 illustrates the second imaging sensor data including a sequence of images, in other example embodiments the second imaging sensor data may include a single snapshot from the second sensor. In that case, control may proceed to 444 to generate a second pixel mapping based on the single snapshot from the second imaging sensor data.

If the second imaging sensor data does include a sequence of images, at 436 control determines whether the calibration artifact pattern is detected in the image capture of the selected image, due to approximately uniform heating. If not, control proceeds to 440 to select a next capture from the second imaging sensor data sequence, and returns to 436 to determine whether the next selected image has uniform heating in order to sufficiently detect the calibration artifact pattern. Once a suitable image capture is selected at 436, control proceeds to 444 to generate a second pixel mapping, from the identified second image pattern to the common coordinate view (e.g., a common world coordinate system (WCS)).

At 448, control is configured to store the determined first pixel mapping, to be applied to future object images captured by the first imaging sensor. At 452, control is configured to store the determined second pixel mapping to apply to future object images captured by the second imaging sensor.

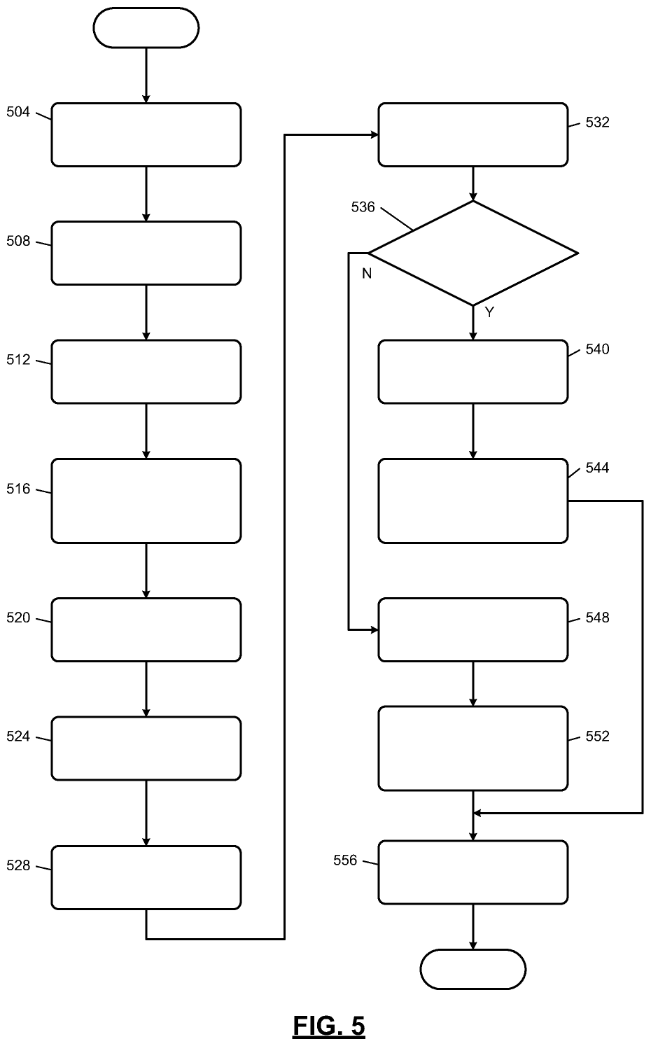

FIG. 5 is a flowchart depicting an example process for mapping an identified target region between images captured by different imaging sensors, using a common coordinate system. At 504, control begins by placing a manufacturing object in view of both imaging sensors.

At 508, control applies a first imaging sensor stimulus, such as a lighting array, to the manufacturing object. Control then captures first imaging sensor data of the manufacturing object at 512, such as a visible light image of the manufacturing object.

At 516, control is configured to apply a second imaging sensor stimulus to the manufacturing object, such as thermally exciting the manufacturing object. Control then captures second imaging sensor data at 520, such as infrared image data of the manufacturing object.

The imaging calibration module is configured to map the first image to the common coordinate system at 524, and to map the second image to the common coordinate system at 528. In some examples, one of the images may already be mapped to the common coordinate system, such that only one of the images needs to be mapped to the common coordinate system.

Control then determines which image will be used for region of interest at section at 532. For example, in some implementations the visible light image may provide a higher accuracy image for ROI selection, and the selected ROI based on the visible light image may be applied to the infrared image. In other examples, the infrared image may provide a higher accuracy image for ROI selection, and the selected ROI based on the infrared image may be applied to the visible light image.

If the first image is used for the region of interest detection at 536, control proceeds to 540 to determine the region of interest based on an image from the first imaging sensor. Control then applies the identified region of interest to the second image from the second imaging sensor, using the common coordinate system at 544.

Alternatively, if control determines at 536 that the first image will not be used for region of interest detection, control proceeds to 548 to determine the region of interest based on the second image from the second imaging sensor. Control then applies the identified region interest to the first image from the first imaging sensor, using the common coordinates at 552.

After applying the region of interest to the other image using the common coordinate system, control performs a manufacturing operation on the object based on the identified region of interest, at 556. For example, control may perform a weld inspection operation on a component based on an identified weld location, or assigning whether a part has passed a quality check.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A calibration system for multiple image sensors, the calibration system comprising:
a manufacturing apparatus configured to perform a manufacturing operation on a manufacturing object;
a first imaging sensor configured to capture an image of the manufacturing object;
a second imaging sensor configured to capture an image of the manufacturing object, wherein the second imaging sensor is positioned at a different location than the first imaging sensor and is configured to capture at least one different wavelength than the first imaging sensor;
a calibration artifact located within a plane of the manufacturing apparatus; and
an imaging calibration module configured to:
obtain a first image of the calibration artifact via the first imaging sensor;
obtain a second image of the calibration artifact via the second imaging sensor;
determine a first pixel mapping between the first image and a common coordinate system, according to a location of the calibration artifact in the first image;
determine a second pixel mapping between the second image and the common coordinate system according to a location of the calibration artifact in the second image;
convert an image of the manufacturing object captured by the first imaging sensor to the common coordinate system according to the first pixel mapping; and
convert an image of the manufacturing object captured by the second imaging sensor to the common coordinate system according to the second pixel mapping.

2. The system of claim 1, wherein the imaging calibration module is configured to:
perform image processing on the image of the manufacturing object captured by the first imaging sensor to identify a target region; and
apply the target region to the image of the manufacturing object captured by the second imaging sensor using the common coordinate system.

3. The system of claim 2, wherein the imaging calibration module is configured to control the manufacturing apparatus to perform the manufacturing operation on the manufacturing object according to the target region as applied to the image of the manufacturing object captured by the second imaging sensor.

4. The system of claim 3, wherein:
the manufacturing apparatus is a weld inspection machine; and
the manufacturing operation includes a weld inspection operation performed on the manufacturing object.

5. The system of claim 1, wherein:
the first imaging sensor is a visible light camera; and
the second imaging sensor is an infrared camera.

6. The system of claim 5, wherein the imaging calibration module is configured to:
activate a light source to illuminate at least one of a front surface of the calibration artifact or a back surface of the calibration artifact while capturing the first image of the calibration artifact using the visible light camera; and
thermally excite at least a portion of the calibration artifact while capturing the second image of the calibration artifact using the infrared camera.

7. The system of claim 6, wherein the imaging calibration module is configured to:
capture a sequence of images while thermally exciting at least the portion of the calibration artifact; and
select one of the sequence of images having a most uniform heat profile as the second image for determining the second pixel mapping.

8. The system of claim 7, wherein the front surface of the calibration artifact includes a material configured to absorb and emit heat in the form of infrared radiation.

9. The system of claim 8, wherein the imaging calibration module is configured to apply infrared radiation to the front surface of the calibration artifact to uniformly heat the calibration artifact while capturing the second image of the calibration artifact using the infrared camera.

10. The system of claim 8, wherein the material on the front surface of the calibration artifact includes a paint material configured to absorb and emit heat in the form of infrared radiation.

11. The system of claim 1, wherein the calibration artifact includes a rectangular plate having a front side, a back side, at least one chamfered corner, and an array of openings defined from the front side to the back side.

12. The system of claim 11, wherein the rectangular plate defines a thickness from the front side to the back side, and each of the openings and each edge of the rectangular plate is chamfered.

13. The system of claim 1, wherein the first imaging sensor is at a different distance from the calibration artifact than the second imaging sensor.

14. The system of claim 1, wherein the first imaging sensor is oriented at a different angle with respect to the calibration artifact than the second imaging sensor.

15. A method of calibrating multiple image sensors, the method comprising:
obtaining a first image of a calibration artifact via a first imaging sensor, the calibration artifact located within a plane of a manufacturing apparatus configured to perform a manufacturing operation on a manufacturing object;
obtaining a second image of the calibration artifact via a second imaging sensor, wherein the second imaging sensor is positioned at a different location than the first imaging sensor and is configured to capture at least one different wavelength than the first imaging sensor;
determining a first pixel mapping between the first image and a common coordinate system, according to a location of the calibration artifact in the first image;
determining a second pixel mapping between the second image and the common coordinate system according to a location of the calibration artifact in the second image;
converting an image of the manufacturing object captured by the first imaging sensor to the common coordinate system according to the first pixel mapping; and
converting an image of the manufacturing object captured by the second imaging sensor to the common coordinate system according to the second pixel mapping.

16. The method of claim 15, further comprising:
performing image processing on the image of the manufacturing object captured by the first imaging sensor to identify a target region; and
applying the target region to the image of the manufacturing object captured by the second imaging sensor using the common coordinate system.

17. The method of claim 16, wherein further comprising controlling the manufacturing apparatus to perform the manufacturing operation on the manufacturing object according to the target region as applied to the image of the manufacturing object captured by the second imaging sensor.

18. The method of claim 17, wherein:
the manufacturing apparatus is a weld inspection machine; and
the manufacturing operation includes a weld inspection operation performed on the manufacturing object.

19. The method of claim 15, wherein:
the first imaging sensor is a visible light camera; and
the second imaging sensor is an infrared camera.

20. The method of claim 19, further comprising:
activating a light source to illuminate at least one of a front of the calibration artifact or a back of the calibration artifact while capturing the first image of the calibration artifact using the visible light camera; and
thermally exciting at least a portion of the calibration artifact while capturing the second image of the calibration artifact using the infrared camera.
